(19) United States
(12) Patent Application Publication
(10) Pub. No.: US 2006/0168349 A1
(43) Pub. Date: Jul. 27, 2006

(54) System and method for enhancing network browsing speed by setting a proxy server on a handheld device

(75) Inventors: Daniel Van Geest, Kitchener (CA); Robbie Maurice, Waterloo (CA)

Correspondence Address: Brij K. Agarwal;Eckert Seamans Cherin & Mellott, LLC, 44th Floor, 600 Grant Street, Pittsburgh, PA, 15219, US

(73) Assignee: Research in Motion Limited

(21) Appl. No.: 11/171,812

(22) Filed: Jun. 30, 2005

Related U.S. Application Data
(60) Provisional application No. 60/639,077, filed on Dec. 22, 2004.

(51) Int. Cl. G06F 15/16

(52) U.S. Cl. 709/247

(57) ABSTRACT

A system for enhancing network-browsing speed by setting a proxy server on a handheld device is disclosed. The system comprises a browser for sending a request for requesting a message from a website and receiving a response in response to the request, a proxy server for transcoding and compressing the request, and transcoding and decompressing the response including the requested message, a wireless network communicably linked to the proxy server, and Mobile Data Service (MDS) gateway communicably linked to the wireless network for transcoding and decompressing the request, and transcoding and compressing the response including the requested message from the website. MDS gateway further receives a redirect response including an address of the requested message and sends a redirect request for requesting the message from the address if there is no requested message at the website, the proxy server sends a notification to the browser with respect to the redirect occurred in the MDS gateway, the browser sends a request to the proxy server for requesting the requested message, and the proxy server sends the requested message to the browser. The redirect occurs between the proxy server and the browser within the handheld device, and does not happen wirelessly to enhance the network browsing speed.

### CROSS-REFERENCE TO RELATED APPLICATION

The instant application claims priority from U.S. Provisional Patent Application Ser. No. 60/639,077 filed Dec. 22, 2004, the disclosures of which are incorporated herein by reference.

### TECHNICAL FIELD OF THE APPLICATION

The present application relates generally to handheld devices, and more particularly to systems and methods for enhancing network-browsing speed by setting proxy servers on handheld devices.

### BACKGROUND

Many handheld devices may access the Internet wirelessly with browsers on the handheld devices. Some of them experience inefficiencies in browsing the Internet. One reason is that the data is sent across the air uncompressed. This increases traffic and lowers browsing speed. Another reason is that the browser may have to make multiple requests before it is able to display a single document. For example, a browser may send a HTTP (Hypertext Transfer Protocol) request via a wireless link to a website to request a webpage, the website may send back a response via the wireless link to the browser to say the requested page is at another website, and then the browser must send another request to the website to fetch the page. Requests and responses are sent back and forth wirelessly multiple times, slowing browsing speed and delaying webpage delivery. Users may lose patience in accessing a message on the Internet.

Therefore, a need has arisen for increasing browsing speed by setting up proxy server on a handheld device to utilize a wireless connection transport system with one over-the-air request and response.

### SUMMARY

A system for enhancing network-browsing speed by setting a proxy server on a handheld device comprises a browser for sending a request for requesting a message from a website and receiving a response in response to the request, a proxy server for transcoding and compressing the request, and transcoding and decompressing the response including the requested message in response to the request, a wireless network communicably linked to the proxy server, Mobile Data Service (MDS) gateway for transcoding and decompressing the request, and transcoding and compressing the response including the requested message from the website.

In one aspect, the MDS gateway further receives a redirect response including an address of the requested message, sends a redirect request for requesting the message from the address and receive the requested message if there is no requested message at the website. The proxy server sends a notification to the browser with respect to the redirect occurred in the MDS gateway. The browser sends a request to the proxy server for requesting the requested message, and the proxy server sends the requested message to the browser.

In one embodiment, a cache is provided in the proxy server for caching images embedded in an HTML response. When the browser requests the images after it examines the HTML response, the proxy will return these images from the cache. MDS gateway transcodes and compresses the HTML response and embedded the images to reduce the number of wireless transactions.

In a further embodiment, the proxy processes a request from browser to add headers for identifying the handheld device's screen dimension and numbers of colors and requesting MDS gateway to resize images to fit the screen dimension. The cache stores the resized images for the browser to request. MDS gateway reduces the image's size before sending image wirelessly to increase network-browsing speed.

### BRIEF DESCRIPTION OF THE DRAWINGS

For a more complete understanding of the features and advantages of the present system and method, reference is now made to the detailed description along with the accompanying figures in which corresponding numerals in the different figures refer to corresponding parts and in which:

FIG. 1 shows an exemplary handheld device which communicates with websites over a wireless network by multiple requests and responses according to prior art;

FIG. 2 shows a wireless connection transport system in which the present application may be implemented wherein one request and one response are sent wirelessly;

FIG. 3 is a block diagram of an embodiment wherein the handheld device of FIG. 1 implements one request and one response to be sent wirelessly by setting up a proxy server in the handheld device and operating in the wireless connection transport architecture of FIG. 2 according to this application;

FIG. 4 is a flowchart of a method for implementing one request and one response sent wirelessly according to a first embodiment of this application;

FIG. 5 is a flowchart showing an embodiment of the method of carrying out the step 420 of FIG. 4;

FIG. 6 is a flowchart showing an embodiment of the method of carrying out the step 425 of FIG. 4;

FIG. 7 is a block diagram wherein a proxy server caches images included in a response according to a second embodiment of this application; and

FIG. 8 is a flowchart of a method for implementing one request and one response sent wirelessly according to the second embodiment of this application.

### DETAILED DESCRIPTION

There is a wireless connection transport architecture which implements one request and one response to be sent wirelessly with Mobile Data Service (MDS). The present application implements a handheld device which may perform multiple requests during accessing Internet to operate in the above wireless connection transport architecture so that a browser on the handheld device accesses Internet with one over-the-air request and response. Therefore, there is a need to interface the browser to the above wireless connection transport architecture. Since most browsers allow their connections to be routed through a proxy, a proxy is set in the handheld device to make the browser to access Internet by means of the above wireless connection transport architecture.

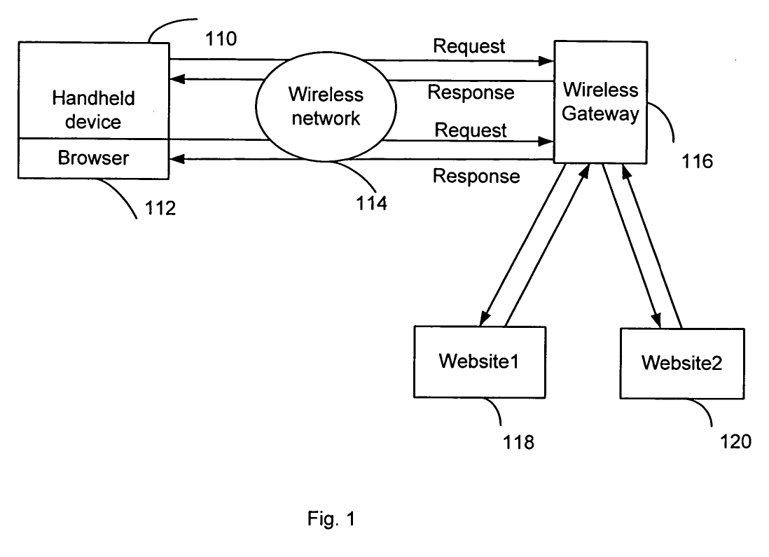

FIG. 1 briefly shows a traditional wireless network that a handheld device communicates with websites by multiple requests according to prior art. Handheld device 110 communicates with wireless gateway 116 via a wireless network 114. Browser 112 in the handheld device 110 sends a HTTP request to website 118 via wireless gateway 116. Website 118 may send a response to browser 112 via wireless gateway 116 to say the requested message is on website 120. Browser 112 sends another request to website 120 to fetch the requested message. Multiple requests and responses are sent in the air to make browsing slow and low efficiency.

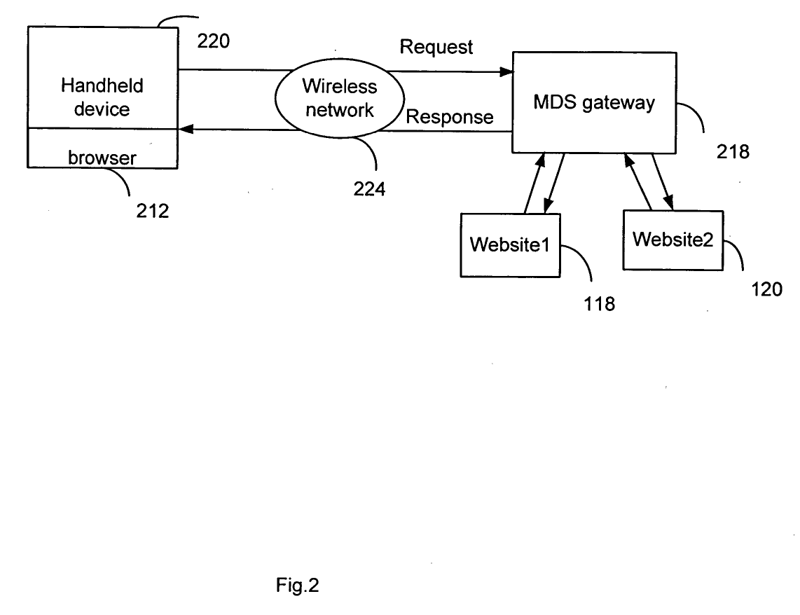

FIG. 2 shows a wireless connection transport system in which the present application may be implemented wherein one request and one response are sent wirelessly. Browser 212 sends a request to MDS gateway 218. MDS Gateway 218 receives a response from website 118 and sends the response to browser 212 by means of MDS gateway 218. If the requested data is not available from website 118, MDS gateway 218 receives a redirect response from website 118, which points it to website 120. MDS gateway 218 then sends a request to website 120 to fetch the requested data. MDS gateway 218 sends one final response to handheld device 220. As shown in this FIG. 2, one request and one response are sent via the wireless network 224.

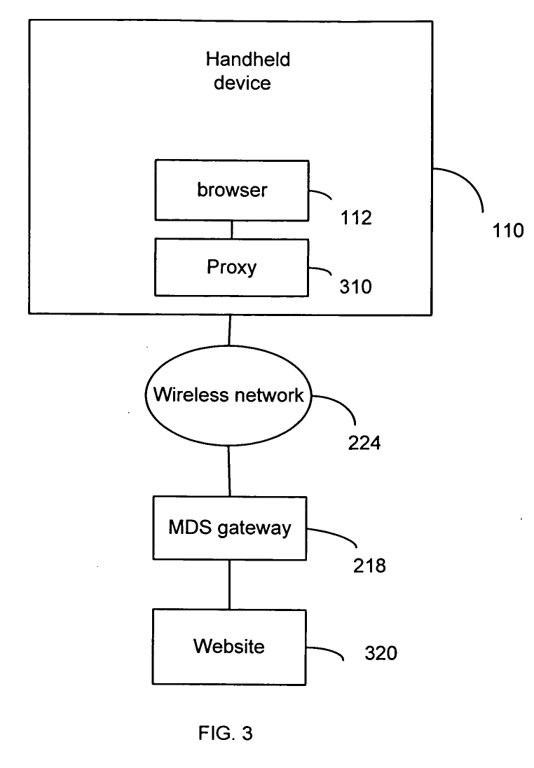

FIG. 3 illustrates a block diagram of an embodiment wherein the handheld device of FIG. 1 implements one request and one response to be sent wirelessly by setting a proxy server on the handheld device and operating in the wireless connection transport system of FIG. 2 according to this application. As shown in FIG. 3, browser 112 operates on handheld device 110. Proxy server 310 is set on the handheld device. Which communicates with MDS gateway 218 via wireless network 224. Proxy server 310 receives a HTTP request, transcodes and compresses it to reduce bandwidth and forwards it to MDS Gateway 218. After processing the request, MDS gateway 218 sends the request to website 320 and website 320 sends a response to MDS gateway 218. MDS gateway 218 may process the response, for example, by transcoding and compressing, and sends the response to proxy 310. Proxy 310 processes the response and sends it to browser 112. If there is a redirect response and a redirect request occurred in MDS gateway 218, MDS gateway 218 receives a redirect response including an actual address of the requested message, sends a request for requesting the redirected response, and receives the requested message. MDS gateway 218 may process the requested message such as by transcoding and compressing and return it to proxy 310. Proxy 310 may process the requested message such as by transcoding and decompressing. Proxy 310 further sends a signal to notify browser 112 that the requested message does not exist at website 320 and a redirect occurred in MDS gateway 218, receives a request signal from browser 112 for requesting the redirected message, and then sends the requested message to browser 112. Proxy 310 may decompress and transcode the responses if the response was transcoded and compressed. Therefore, one request and one response occur wirelessly. Redirect occurs between MDS gateway 218 and websites and subsequently between browser 112 and proxy 310 within handheld device 110. It does not occur wirelessly. MDS gateway may perform many types of transcoding, for example, it tokenizes HTTP headers to reduce bandwidth, transcodes images in order to reduce bandwidth and make them fit a small screen, transcodes HTML to reduce bandwidth, and send HTML and images together in one response to save the handheld from having to make multiple wireless requests.

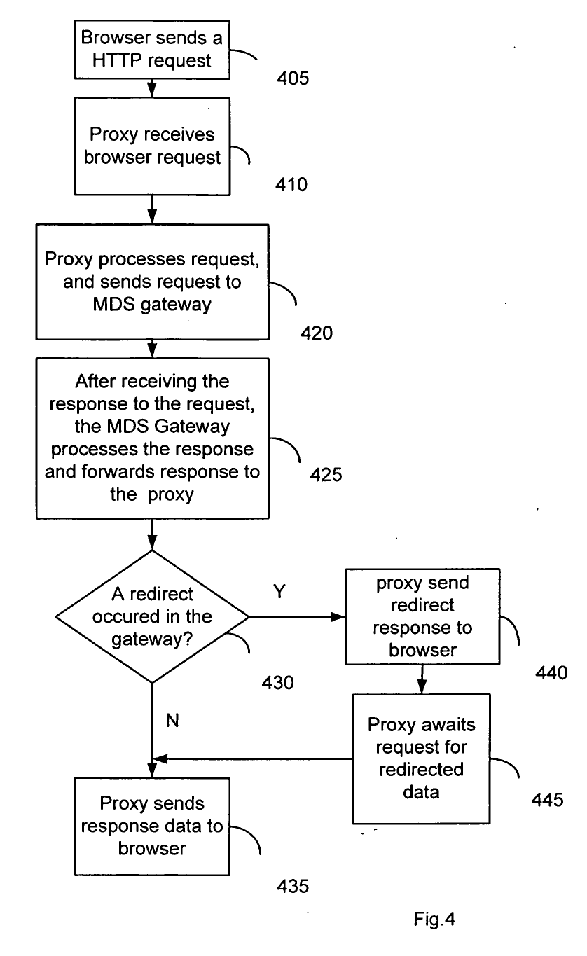

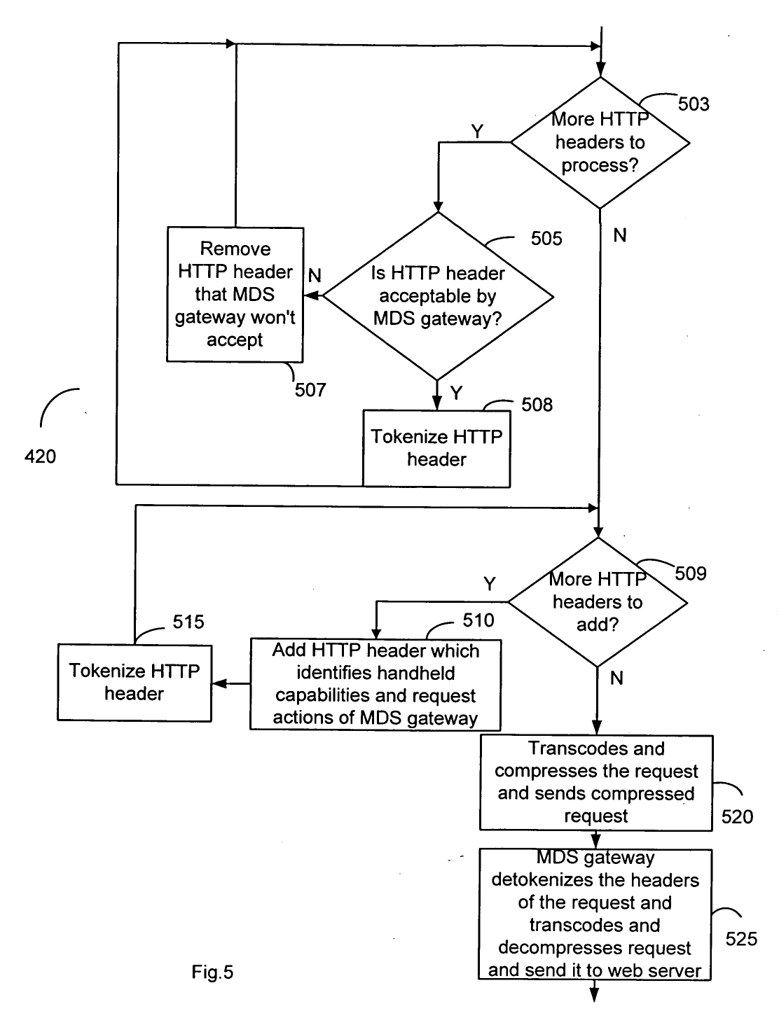

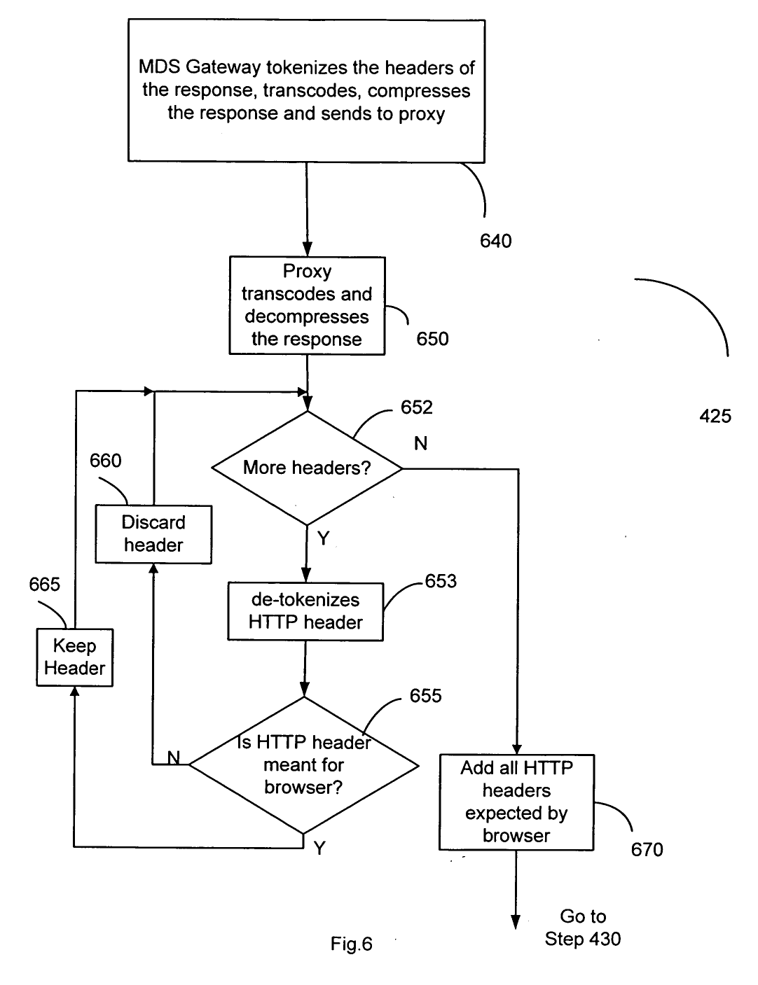

FIG. 4 is a flowchart showing a first embodiment of a method for implementing one request and one response sent wirelessly. Browser 112 sends a HTTP request for a message at a website 320 at step 405, and proxy server 310 receives the HTTP request at step 410. At step 420, proxy server 310 processes the header of the request so that MDS gateway 218 accepts the request, transcodes and compresses the request, and then proxy server 310 sends the request to MDS gateway 218. At step 425, MDS gateway 218 receives response data from the website 320, processes the response, and sends the response to proxy server 310. The details of steps 420 and 425 will be further described in FIG. 5 and FIG. 6. At step 430, it is determined if a redirect has occurred in the gateway. If no, proxy server 310 sends the requested message response data to browser 112 at step 435. MDS gateway 218 also processes a redirect when the requested message is not at website 320. MDS gateway 218 receives a redirect response including an actual address of the requested message from a server (not shown), and sends a redirect request for requesting the requested message from the address, and then MDS gateway 218 receives the requested message. This redirect does not happen wirelessly. If a redirect occurred in MDS gateway 218, proxy server 310 sends a notification signal containing the actual address of the requested message to browser 112 and notifies there is a redirect occurred in MDS gateway 218 at step 440, and receives a request signal for requesting the redirected data from browser 112 at step 445, and then proxy server 310 sends the requested message to browser 112 at step 435. The redirected message may be processed in MDS gateway 218 and proxy server 310 at step 425 as described with reference to FIG. 6 in detail.

These multiple requests resulted from a redirect occur between proxy server 310 and browser 112 within handheld device 110. It does not happen wirelessly. Therefore, the browsing speed is enhanced.

FIG. 5 is a flowchart showing an embodiment of the method of carrying out the step 420 of FIG. 4. A HTTP request may have one or more header fields, and each field includes a header. A HTTP request may not have any header field. Each HTTP header field is examined individually. At step 503, it is determined if there are more HTTP header fields to be processed. If not, the process proceeds to 509. If there is any HTTP header field to be processed, it proceeds to 505 where proxy server 310 reads a HTTP header field and determines if the HTTP header of the HTTP header field is accepted by MDS gateway 218. If yes, proxy server 310 tokenizes the header at 508 and then the process returns to 503. If the HTTP header is not accepted, the HTTP header is removed at step 507, and the process returns to 503. When all the headers in the header fields have been processed, the processes goes to 509 where it is determined if there are HTTP headers required by MDS gateway 218 to be added. If there is any HTTP headers required to be added, the process goes to 510 where a HTTP header which identifies the handheld device capabilities and requests actions of MDS gateway 218 is added, and at 515, the HTTP header is tokenized. If there are no more headers to be added, at step 520, proxy server 310 transcodes and compresses the HTTP request to reduce the amount of data sent over the air. At step 525, MDS gateway 218 de-tokenizes the HTTP headers of the request, decompresses and transcodes the request and sends it to a website.

FIG. 6 is a flowchart showing an embodiment of the method of carrying out the step 425 of FIG. 4. MDS gateway 218 receives requested response data from a website, tokenizes the HTTP headers of the response, transcodes and compresses the requested response data and sends it to the proxy 310 wirelessly at step 640. The proxy 310 decompresses the requested response at step 650. The HTTP headers in HTTP header fields are examined. At step 652, it is determined if there is any HTTP header included in the requested response to be examined, and if there is no HTTP headers to be examined, the process proceeds to 670 where any extra headers that the browser expects are added and then proceeds to step 430. If there are more headers to be examined, one unexamined HTTP header is read and is de-tokenized at step 653. At step 655, it is determined if the HTTP header is accepted by the browser 112, and the process goes to step 660 where the HTTP header is discarded if the header is not accepted by the browser 112, or goes to 665 where the header is kept if the header is accepted by the browser 112. The next header is then examined at step 652 again until all headers are examined.

In this embodiment, the requested response may be an HTML, XML, WML, or other response, and may include one or more images, webpages, documents, or a combination of document and image.

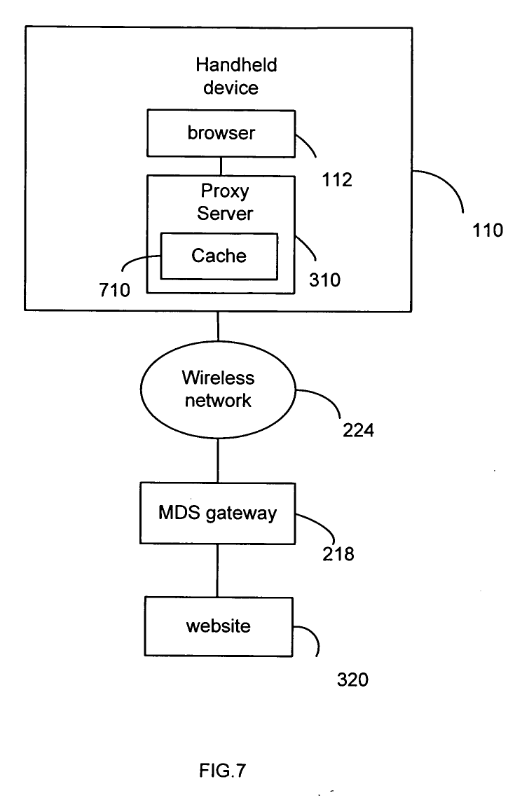

FIG. 7 is a block diagram wherein a proxy server stores images included in a response according to a second embodiment of this application. The MDS Gateway may send a response including multiple documents such as a text document and images. For example, a response may include an HTML page and one or more images referenced in the HTML page. When a browser receives the HTML response, after checking the response, it may send another request to fetch images over the air. In this embodiment, a cache 710 is provided in proxy server 310 for storing images that were embedded in the response. When the browser requests images after checking the response, the proxy 310 sends the images without having to make another over-the-air request, so it makes browsing fast. As shown FIG. 7, cache 710 is set in the proxy server 310 for storing images in a response.

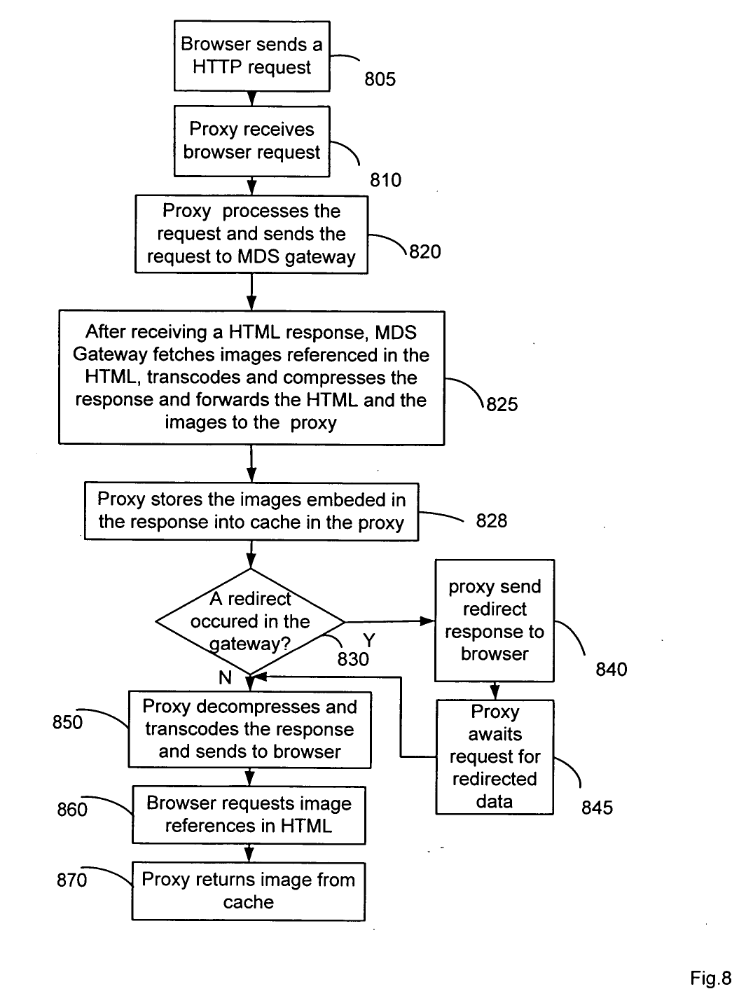

FIG. 8 is a flowchart of a method for implementing one request and one response sent wirelessly according to the second embodiment of this application, as shown in FIG. 7. Browser 112 sends an HTTP request for a message at website 320 at step 805, and proxy server 310 receives the HTTP request at step 810. The proxy 310 processes the request and sends the request to MDS gateway 218 at step 820. The process of step 820 is same as that of step 420 shown in FIG. 5. At step 825, MDS gateway 218 receives an HTTP response such as an HTML response and fetches any images referenced in the HTML, transcodes and compresses the response to reduce the amount of data and bandwidth, and sends the response data including HTML documents and images to the proxy server 310. The process of step 825 is similar to step 425 shown in FIG. 6 where the headers of the HTTP response are processed. Proxy 310 stores the images embedded in the response into cache 710 at step 828. At step 830, it is determined if a redirect occurred in the gateway. If a redirect occurred in the gateway, proxy server 310 sends a notification signal including the actual location of the requested message to the browser 112 and notifies it that a redirect occurred in MDS gateway 218 at step 840, and receives a request for redirected data from browser 112 at step 845. This notification signal and the request signal for redirected data between proxy server 310 and browser 112 occur within handheld device, and do not happen wirelessly. Therefore, the network-browsing speed is increased. At step 850, proxy 310 decompresses and transcodes the response back into its original format such as HTML format, and then sends the response to browser 112. The browser 112 then requests an image referenced in the HTML response at step 860, and the proxy 310 finds the image in cache 710 at step 870, so it sends this image data and avoids a wireless request.

In this embodiment, the MDS gateway transcodes and compresses the HTML response, it allows only one over-the-air request and response for multiple documents which may include HTML pages and images. Alternatively, the response in this embodiment may be a WML, XML or other existing webpage response format.

In one embodiment, browser 112 may request an image document that only includes one or more images. MDS gateway 218 sends the requested images, and caches 710 stores the requested images for browser 112 to request the images within handheld device. This avoids image transmission wirelessly.

In a further embodiment, MDS gateway 218 may resize the requested images to fit the handheld device's screen capabilities. In this embodiment, at step 510 of FIG. 5, the headers which identify handheld device's screen dimensions and/or number of colors and request MDS gateway 218 to resize images are added. MDS gateway 218 utilizes the headers to resize the requested images. MDS gateway 218 sends the requested image in a response, either by itself or embedded in a HTTP response or a text, depending on what was requested by browser 112. Proxy server 310 caches images if browser 112 requested the image only or requested embedded images in a HTTP response or a text, and then proxy server 310 just returns the image to browser 112 when browser 112 requests the image. This saves a lot of bandwidth since large images may be reduced before they are transmitted wirelessly, avoids multiple transmission of images wirelessly, and increases the network browsing speed.

The requests from the browser and responses from website as described above are not limited to HTTP requests and HTTP responses, and they may be any TCP (transmission control protocol) request and response, and any UDP (User Datagram Protocol) request and response. Those skilled in the art will appreciate that TCP request and response include, but not limited to HTTP, FTP (file transfer protocol), Telnet, Finger, SSH (secure shell), DNS (Domain Name Server), POP3/IMAP, SMTP, Gopher, BGP (Border Gateway Protocol), Time/NTP, whois, TACACS+, SSL (Secure Sockets Layer), RTSP (Real-time Streaming Protocol), LDAP (Directory Access Protocol).

We claim:

1. A system for enhancing network-browsing speed by setting a proxy server on a handheld device, comprising:
a browser operating on the handheld device for sending a request for requesting a message from a website and receiving a response in response to the request;
a proxy server setting on the handheld device for transcoding and compressing the request, and transcoding and decompressing the response including the requested message in response to the request;
a wireless network communicably linked to the proxy server; and
a Mobile Data Service (MDS) gateway communicably linked to the wireless network for transcoding and decompressing the request, and transcoding and compressing the response including the requested message from the website.

2. The system of claim 1, wherein
the MDS gateway further receives a redirect response including an address of the requested message, sends a redirect request for requesting the message from the address and receives the requested message if there is no requested message at the website;
the proxy server sends a notification to the browser with respect to the redirect occurred in the MDS gateway;
the browser sends a request to the proxy server for requesting the requested message; and
the proxy server sends the requested message to the browser.

3. The system of claim 1, wherein the request includes multiple headers, the proxy server examines headers of the request individually, removes the header not acceptable by the MDS gateway, adds the header acceptable by the MDS gateway, and tokenizes the header.

4. The system of claim 3, wherein the MDS gateway de-tokenizes the headers of the request.

5. The system of claim 1, wherein the MDS gateway tokenizes the header of the response.

6. The system of claim 1, wherein the response includes multiple headers, the proxy server examines each header individually, de-tokenizes each header, removes the header not acceptable by the browser, and adds the header acceptable by browser.

7. The system of claim 1, wherein the request for requesting the message is a protocol request using TCP connection.

8. The system of claim 1, wherein the request for requesting the message is a protocol request using UDP.

9. A method for enhancing network-browsing speed by setting a proxy server on a handheld device, comprising:
sending a request for requesting a message from a website by a browser operating on the handheld device;
transcoding and compressing the request by the proxy server;
sending the request to a MDS gateway via a wireless network;
transcoding and decompressing the request by the MDS gateway;
receiving a response from the website by the MDS gateway;
transcoding and compressing the response by the MDS gateway;
sending the response to the proxy server via the wireless network;
transcoding and decompressing the response by the proxy server; and
receiving the response by the browser.

10. The method of claim 9, further comprising:
receiving a redirect response including an address of the requested message by the MDS gateway if the requested message is not at the website;
sending a redirect request for requesting the requested message from the address by the MDS gateway; and
receiving a response including the requested message by the MDS gateway.

11. The method of claim 10, further comprising:
sending a notification including an address of the requested message to the browser and regarding no the requested message at the website by the proxy server;
receiving a request for requesting the requested message from the browser; and
sending the response including the requested message to the browser by the proxy server.

12. The method of claim 9, before the step of transcoding and compressing the request by the proxy server, further comprising:
examining the headers of the request;
removing the header not acceptable by the MDS gateway;
adding the header acceptable by MDS gateway; and
tokenizing the header.

13. The method of claim 12, before the step of transcoding and decompressing the request by the MDS gateway, further comprising de-tokenizing the headers of the request.

14. The method of claim 9, before the step of transcoding and compressing the response by the MDS gateway, further comprising tokenizing the headers of the response.

15. The method of claim 14, after the step of transcoding and decompressing the response by the proxy server, further comprising:
examining the headers of the response;
de-tokenizing the headers;
removing the header not acceptable by the browser; and
adding the header acceptable by browser.

16. The method of claim 9, wherein the request is a protocol request using a TCP connection.

17. The method of claim 9, wherein the request is a protocol request using UDP.
